(19) United States
(12) Patent Application Publication
(10) Pub. No.: US 2019/0120212 A1
(43) Pub. Date: Apr. 25, 2019

(54) PROPULSION FROM ROTATING MEMBERS

(71) Applicant: Christopher B. Hewatt, Denver, CO (US)

(72) Inventor: Christopher B. Hewatt, Denver, CO (US)

(21) Appl. No.: 15/790,146

(22) Filed: Oct. 23, 2017

(51) Int. Cl. F03G 3/08

(52) U.S. Cl. CPC F03G 3/08; G01C 19/02

(57) ABSTRACT

A propulsion system includes a rotation member, a first mass and a motor. The rotation member has a length extending between first and second ends and an axle of rotation between the first and second ends transverse to the length. The first mass is coupled with the rotation member at the first end and rotatable relative to the rotation member about a first mass axis. The first motor is configured to, while the rotation member is rotating about the axle of rotation, translate the axle of rotation along a path perpendicular to both the length and the axle of rotation by applying a force to accelerate rotation of the first mass about the first mass axis.

### SUMMARY

It is an object of the disclosure to describe a propulsion system including a rotation member having a length extending between first and second ends and an axle of rotation between the first and second ends transverse to the length. A first mass is coupled with the rotation member at the first end and rotatable relative to the rotation member about a first mass axis. A first motor is configured to, while the rotation member is rotating about the axle of rotation, translate the axle of rotation along a path perpendicular to both the length and the axle of rotation by applying a force to accelerate rotation of the first mass about the first mass axis.

It is another object of the disclosure to describe a method for arranging a propulsion system. The method includes providing a rotation member having a length extending between first and second ends and an axle of rotation between the first and second ends transverse to the length; rotatably coupling a first mass with the first end of the rotation member; and operatively coupling a first motor with the first mass such that the motor translates the axle of rotation along a path perpendicular to both the length and the axle of rotation by applying a force to accelerate rotation of the first mass about the first mass axis.

It is an additional object of the disclosure to describe a method for propulsion. The method includes, to a payload carrying system, providing a rotation member having a length extending between first and second ends and an axle of rotation transverse to the length; rotatably coupling a first mass with the first end of the rotation member; rotating the rotation member relative to the payload carrying system about the axle of rotation; rotating the first mass relative to the rotation member; with the rotation member and the first mass rotating, translating the payload carrying system along a travel path perpendicular to the axle of rotation by accelerating rotation of the first mass with a first motor.

### BRIEF DESCRIPTION OF THE FIGURES

The summary above, as well as the following detailed description of illustrative embodiments, is better understood when read in conjunction with the appended drawings. For the purpose of illustrating the disclosed systems and methods, example constructions of are shown in the drawings. However, the present disclosure is not limited to specific methods and instrumentalities described herein. Moreover, those in the art will understand that the drawings are not to scale. Wherever possible, like elements have been indicated by identical numbers.

Embodiments of the disclosure will now be described, by way of example only, with reference to the following diagrams wherein:

FIG. 1 illustrates a top view of an example propulsion system.

FIG. 2 illustrates a front view of the example propulsion system of FIG. 1.

FIG. 3 illustrates a side view of the example propulsion system of FIGS. 1 & 2.

FIG. 4 illustrates a top view of the example propulsion system of FIGS. 1-3 operatively coupled with a payload carrying system in the form of a carriage and configured to propel the carriage.

FIG. 5 illustrates a front view of the example propulsion system of FIGS. 1-3 operatively coupled with a payload carrying system in the form of a carriage and configured to propel the carriage.

FIG. 6 illustrates a side view of the example propulsion system of FIGS. 1-3 operatively coupled with a payload carrying system in the form of a carriage and configured to propel the carriage.

FIG. 7 illustrates a side view of the example carriage of FIGS. 4-6 positioned within a guiding track.

FIG. 8 illustrates a top view of an example propulsion system in an instant of rotation about axis 155 (FIG. 2).

FIG. 9 illustrates a top view of an example propulsion system at an instant of application of a decelerating torque to first mass 261.

### DETAILED DESCRIPTION

The following detailed description illustrates embodiments of the present disclosure and manners by which they can be implemented. Although the best mode of carrying out the present disclosure has been described, those having ordinary skill in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

The term accelerate and it's derivatives (accelerating, acceleration, etc.) are intended to encompass not only positive acceleration which tends to increase speed but also negative acceleration, also referred to as deceleration, which tends to decrease speed. Further, it should be noted that acceleration may also affect a change in velocity not affecting speed, for example, by changing direction.

As demand for hydrocarbon energy skyrockets and hydrocarbon energy reserves continue to decline, an energy crisis may be confronting the civilized world. A number of measures are being taken to avoid a crisis. More efficient hydrocarbon engines are now in widespread use. Hybrid vehicles with regenerative braking have been introduced. Research and development of fuel cell technology continues at a rapid pace. Even with these measures, there remains a need for a highly efficient propulsion system.

Gyroscopic propulsion systems have been developed to address this need. Gyroscopic systems can theoretically propel an object without relying on frictional forces—the key forces used by conventional vehicles. A gyroscope is generally a disk free to rotate about an axis which itself may be confined within a framework that is free to rotate about one axis or two. The two qualities of a gyroscope that account for its usefulness are: first, the axis of a free gyroscope will remain fixed in space provided no external forces act upon it, and, second, a gyroscope can be made to deliver a torque which is proportional to the angular velocity about a perpendicular axis. Both qualities stem from the principle of conservation of momentum under which the total angular momentum of the system relative to any point fixed in space remains constant provided that no external forces act on the system. In a typical gyroscopic propulsion system, a number of rotating gyroscopes are themselves rotated around a common point. The gyroscopes are misbalanced, causing a displacement of the propulsion system. As will be appreciated, an imbalance can create a propulsive force.

These systems have been largely unsuccessful however because they have generally failed to generate sufficient propulsive forces to be practical.

These and other needs are addressed by the various embodiments and configurations disclosed herein. The disclosure is directed generally to a propulsion system and method that uses torque applied unequally around the circumference of a rotating body to impart a propulsive force. Embodiments of the present disclosure substantially eliminate, or at least partially address, problems in the prior art, avoiding frictional forces and not relying on hydrocarbon fuel.

Disclosed flywheel propulsion systems are configured to propel an object without relying on frictional forces. A flywheel, a disk free to rotate about an axis, similar to a gyroscope has at least two qualities that may be harnessed for propulsion: first, the axis of a rotating flywheel will remain fixed in space provided no external forces act upon it, and, second, a flywheel can be made to deliver a torque which is proportional to the angular velocity about an axis perpendicular the flywheel axis. Both qualities stem from the aforementioned principle of conservation of momentum.

In a typical flywheel propulsion system, a number of rotating flywheels are themselves rotated around a common point. The flywheels are subsequently accelerated resulting in displacement of the propulsion system. The direction of displacement of a vehicle, carriage or other payload supporting system including the propulsion system is normal to a line extending from the axis of rotation of the rotating member to a center of one of the flywheels.

The position of the rotating member at the time when a torque is applied to at least one of the flywheels can be changed to adjust a direction of displacement. For example, a carriage can be decelerated by changing the position of application of a torque so that the resulting direction of displacement is substantially opposite to the vehicle's current direction of displacement.

Without using friction or aerodynamic forces, the propulsion system and associated method can advantageously provide displacement of a vehicle, such as an aircraft, hovercraft, spacecraft or other payload carrying system. In other words, the propulsion system can be frictionless and thereby can provide a highly efficient method of propulsion. Unlike gyroscopic propulsion systems, the system of the present invention does not require use of imbalance to impart motion.

Additional aspects, advantages, features and objects of the present disclosure will be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

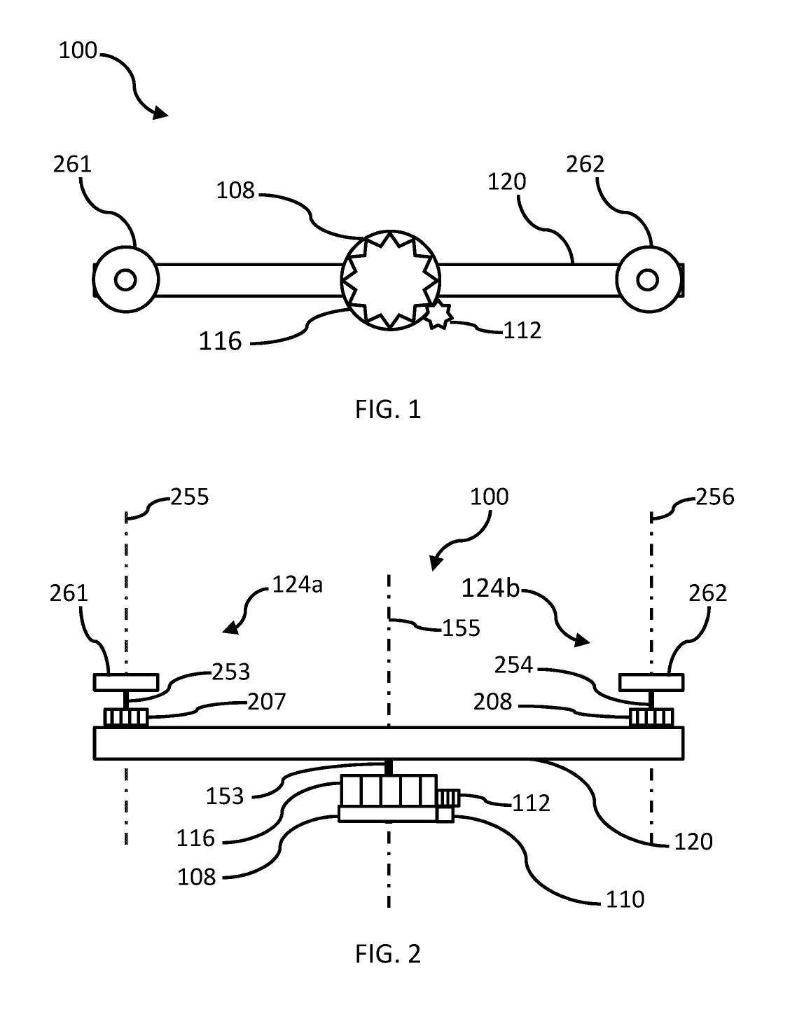

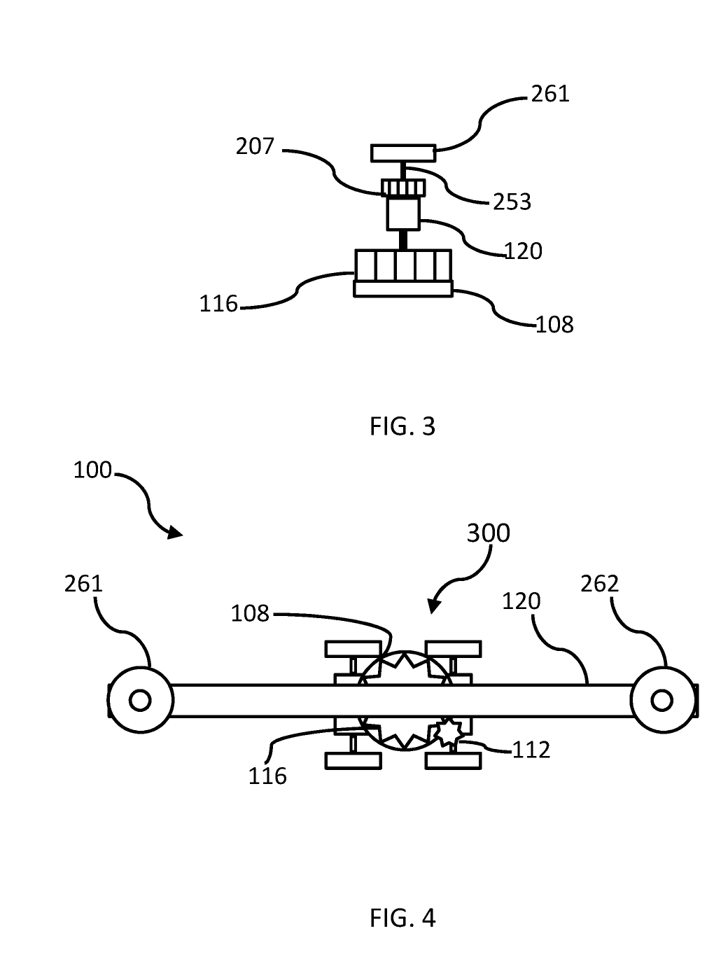

Referring to FIGS. 1-3, a propulsion system includes a drive assembly 100, an engine 110 for rotating the drive assembly 100, and a mounting member 108 to which the assembly 100 is rotatably connected, such as by one or more gears or bearings (not shown). The mounting member 108 may be physically connected to a vehicle that is to be propelled by the propulsion system. The engine 110 rotatingly engages a gear 112 that interlockingly engages (meshes with) a drive gear 116 to rotate assembly 100.

Assembly 100 includes a rotation member 120 nonrotatably connected to the drive gear 116 as well as first and second drive members 124a and 124b (collectively referred to as dive members 124). The rotation member 120 has a length extending between first and second ends and an axle of rotation 153 between the first and second ends transverse to the length. First drive member 124a is coupled with the rotation member 120 at the first end and includes a first motor 207 configured to apply a torque to an axle of rotation 253 of a first mass 261 to accelerate rotation of first flywheel or mass 261 about first mass axis 255 which is parallel with axle of rotation 153 of rotation member 120 and axis 155. Second drive member 124b is coupled with the rotation member 120 at the second end opposite the first drive member 124a, and includes a second motor 208 configured to apply a torque to an axle of rotation 254 of a second flywheel or mass 262 to accelerate rotation of second mass 262 about a second mass axis 256 which is parallel with axle of rotation 153 of rotation member 120 and axis 155.

The first motor 207 is configured to, while the rotation member 120 is rotating about axle 153, translate axle 153 along a path perpendicular to both the length and axle 153 by applying a torque to accelerate rotation of the first mass 261 about first mass axis 255.The second motor 208 is configured to, while the rotation member 120 is rotating about axle 153, translate axle 153 along a path perpendicular to both the length and axle 153 by applying a force to accelerate rotation of the second mass 262 about the second mass axis 256.

In an example the first motor 207 and the second motor 208 include stepper motors.

The masses 261 and 262 can be any structure including one or more symmetrical disks, which are typically relatively heavy (e.g., 150 pounds or more), disposed about the central axle or shaft 153 that is free to rotate about the axis of rotation 155. Drive members 124, which have axes that will resist changes in direction, can deliver a torque proportional to the angular velocity about their axes. Under the principle of conservation of angular momentum, the total angular momentum of any system of particles relative to any point fixed in space remains constant, provided no external force(s) act on the system.

Typically, drive members 124 are rotatably connected to rotating member 120, such as by one or more gears or bearings (not shown). As discussed below, the direction of rotation of each of the drive members 124 is commonly the same as the direction of rotation of the rotating member 120. However, other configurations may be employed. While two drive members are depicted by way of example, any number of drive members 124 may be employed. In an example, various drive members 124 are separated by a substantially equal circumferential distance.

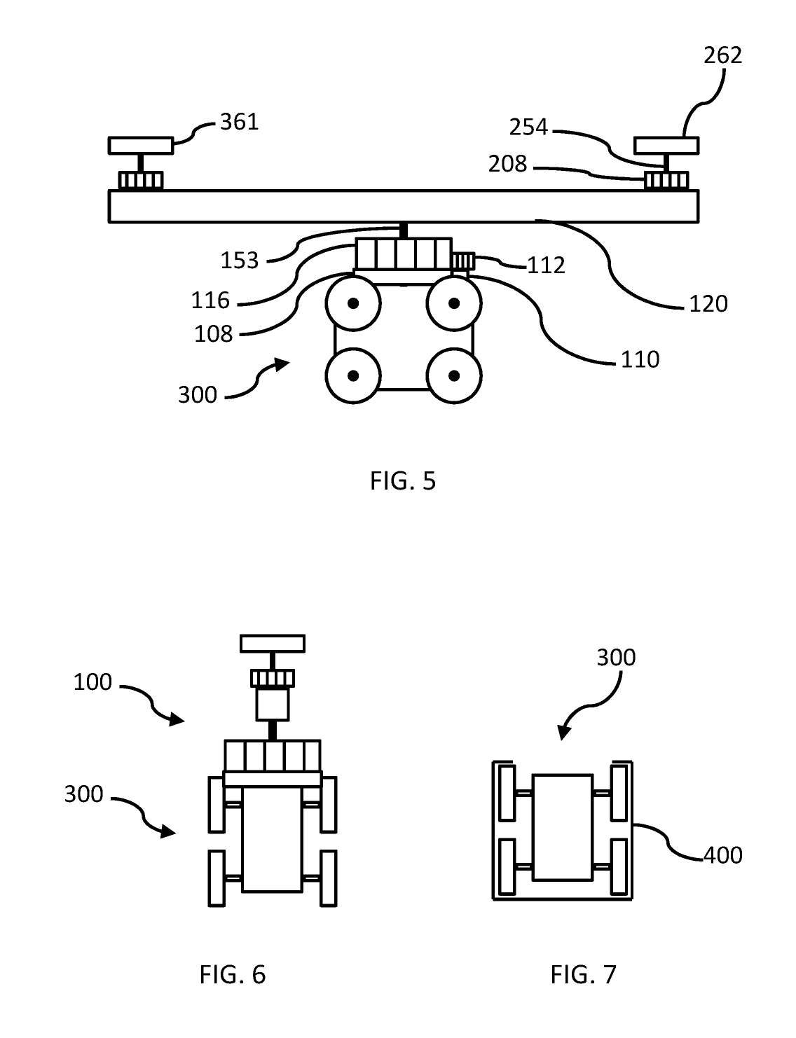

A method for arranging a propulsion system will now be described with respect to FIGS. 4-7. A rotation member 120 is provided with a length extending between first and second ends and an axle of rotation 153 between the first and second ends transverse to the length. An engine 110 is operatively coupled with the rotation member 120 so as to selectively cause rotation of the rotation member 120 about the axle of rotation (FIG. 2).

A first mass 261 is rotatably coupled with the first end of the rotation member 120 about a first mass axis (FIG. 2) parallel with the axle of rotation member 120 and a first motor 207 is coupled with the first mass 261 such that the motor 207 translates the axle of rotation 153 of rotation member 120 along a path perpendicular to both the length and the axle of rotation by applying a force to accelerate rotation of the first mass 261 about the first mass axis.

A second mass 261 is rotatably coupled with the second end of the rotation member 120 about a second mass axis (FIG. 2) parallel with the axle of rotation 153 of the rotation member 120 and a second motor 208 is coupled with the second mass 262 such that the motor 208 translates the axle of rotation 153 of the rotation member 120 along a path perpendicular to both the length and the axle of rotation by applying a force to accelerate rotation of second mass 262 about second mass axis 256. Finally, before propulsion, a carriage 300 or other payload carrying system is coupled with the rotation member 120.

The operation of the propulsion system 100 will now be discussed.

According to a method of propulsion, a rotation member 120 is provided to a carriage 300 or other payload carrying system, with a length extending between first and second ends and an axle of rotation 153 transverse to the length. A first mass 261 is rotatably coupled with the first end of the rotation member 120. The rotation member 120 is rotated relative to the carriage 300 about axle of rotation 153.

To initiate propulsion, the engine 110 places rotating member 120 in a first direction of rotation. Before, during, or after rotation of the rotating member 120, the respective motors 207 and 208 of each drive member 124 place the masses 261 and 262 in rotation. As the rotating member 120 rotates, the various drive members 124 are driven in the same direction of rotation. As will be appreciated, the relative orientations of each of the drive members relative to the rotating member 120 and to one another is generally unimportant. When the various rotating members are rotating at desired rotational speeds, the propulsion sequence is initiated.

With the rotation member 120 and first mass 261 rotating, carriage 300 is translated along a travel path perpendicular to axle of rotation 153 by accelerating rotation of first mass 261 with first motor 207. Accelerating rotation of the first mass 261 may be enacted with, for example, a stepper motor.

In an example, a second mass 262 is rotatably coupled with the second end of the rotation member 120 about a second mass axis 256 parallel with axle of rotation 153 of rotation member 120. The coupled second mass 262 is rotated relative to rotation member 120. With rotation member 120 and second mass 262 rotating, carriage 300 is translated along a travel path perpendicular to the axle of rotation 153 by accelerating rotation of second mass 262 with second motor 208. As with first mass 261, accelerating rotation of the second mass 262 may be enacted with, for example, a stepper motor.

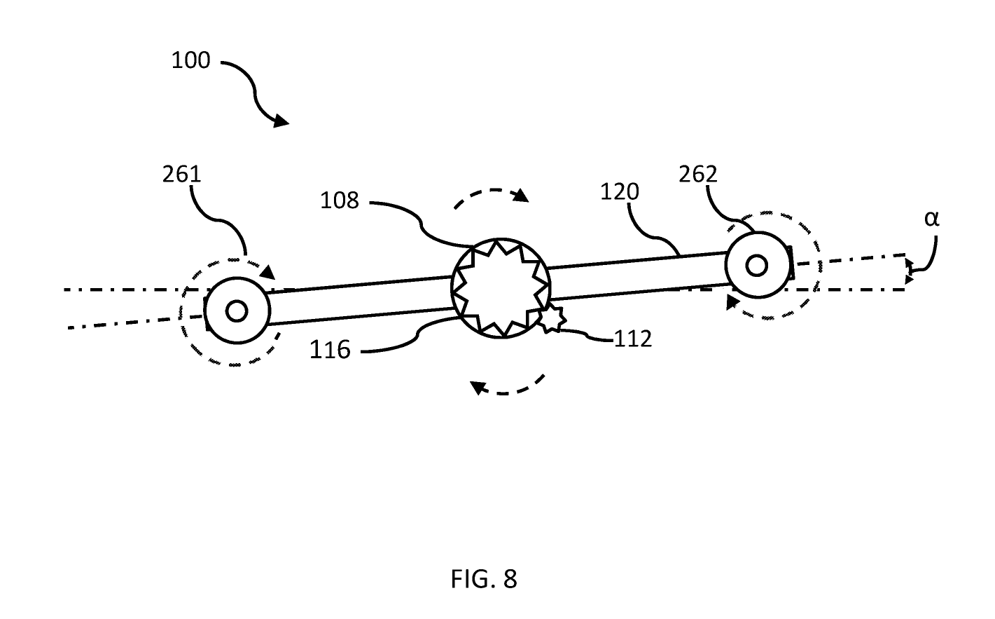

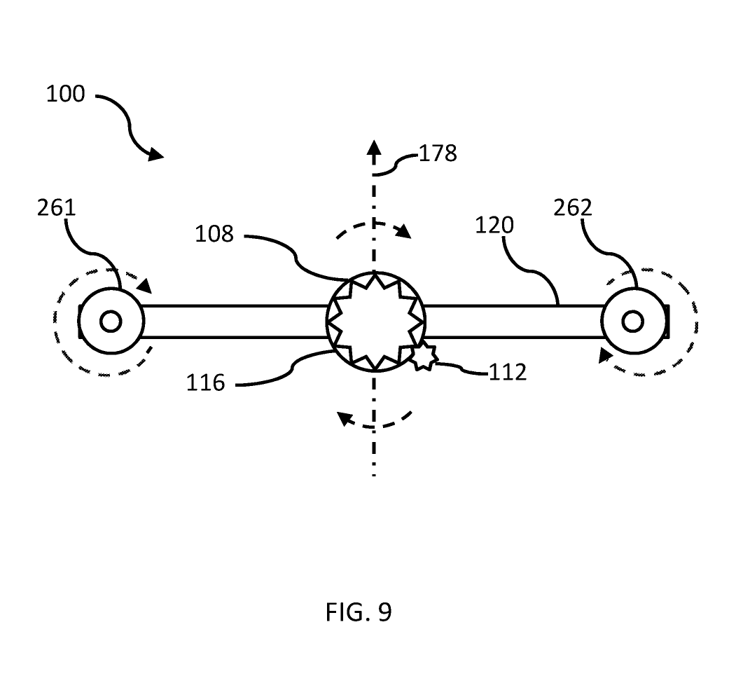

The propulsion sequence will now be discussed with reference to FIGS. 8 & 9. To understand the operation of the system, it is important to understand the operational modes of each of the drive members. In the constant angular velocity state, no torque is applied to the masses about their respective rotational axis 255 and 256. This state is shown in FIG. 8. In the state of acceleration, an accelerating torque is applied to the masses to substantially instantaneously increase or decrease the angular velocity about their respective axes 255 and 256. Each mass 261 and 262 is accelerated by the stepper motor 207 or 208 being applied against the axis 255 or 256. This state is shown in FIG. 9. First mass 261 resists acceleration around axis of rotation 255 due to angular momentum and a new axis of rotation of the rotating member 120 is established. The new axis of rotation is coincident with axis 255 located at the center of the drive member 124a. Stated another way, the axis of rotation 155 of the rotating member 120 effectively rotates about the new axis of rotation. This causes spatial displacement of the axis of rotation 155 and therefore of the carriage containing the system 100. Similarly, when second mass 262 reaches the location of first mass 261 as shown in FIG. 9, and a torque is applied from motor 208, and second mass 262 resists acceleration around axis of rotation 256 and a new axis of rotation of the rotating member 120 is established coincident with axis 256.

In certain configurations, the resistance of masses 261 and 262 to being rotated while in acceleration is attributable to the phenomenon of precession. This phenomenon is explained by Newton's law of motion for rotation under which the time rate of change of angular momentum about any given axis is equal to the torque applied about the given axis. Stated another way, the rate of rotation of the axis of rotation about a transversely oriented axis is proportional to the applied torque.

Referring now to FIGS. 8 & 9, the propulsion sequence will be described in detail. As can be seen from FIG. 8, generally, while first and second masses 261 and 262 and rotation member 120 are rotating about their respective axes/axles in a clockwise orientation, the system is not being driven in translation. Translation is affected when the first mass 261 and/or the second mass 262 are accelerated at a pre-determined angle of rotation of rotation member 120. While translation can be effected at any desired trajectory by accelerating the first 261 and/or second 262 masses at the corresponding angle of rotation, in an example, the first and/or second masses are accelerated when the angle a is approximately 0 degrees.

As shown in FIG. 9 by example, when the angle a (FIG. 8) is approximately 0 degrees and an acceleration is applied to first mass 261, the system and any associated payload carrying system (carriage 300, for example) are translated in the direction of arrow 178. Realistically, instantaneously applying a torque to either of masses 261 may be impractical. In practice, a torque accelerating either of masses 261 to affect a translation of rotation member 120 and the system, is applied over a small angle range when rotation member 120 is approximately perpendicular with the desired trajectory of propulsion. For example, the torque may be applied while the angle a measures between about −5 and about 5 degrees. In another example, the torque may be applied while the angle a measures between about −2 and about 2 degrees. In yet another example, the torque may be applied while the angle a measures between about −1 degree and about 1 degree.

To create a desired acceleration and/or velocity of displacement, rotational speeds of rotating member 120 and drive members 124 are adjusted. For lower speeds, rotating member rotational speeds are reduced and, for higher speeds, rotating member rotational speeds are increased.

To brake or slow the systems, the angle of the accelerating is altered so that it is opposite to the current direction of displacement. For example, a torque may be applied to second mass 262 rather than the first mass when the angle a measures approximately 0 degrees. Alternatively, a torque may be applied to the first mass 261 when the angle a measures approximately 180 degrees. Likewise to change the direction of displacement, the angle at which the torque is applied is changed accordingly. For example, if a torque is applied to first mass 261 while the angle a is approximately 90 degrees, the system and any associated carriage will be translated along a trajectory perpendicular to arrow 178 (FIG. 9). This may be readily accomplished by mechanical or electromechanical techniques.

The control of the position of the acceleration and the rotational speeds of rotating member 120 and drive members 124 can be effected by user manipulatable mechanical linkages and/or by a logic circuit or software that receives user input, such as by a joystick, and provides appropriate command signals to the engine, and/or motors to implement the commands.

The propulsion system can be used to propel any type of vehicle, carriage or other payload carrying system in any direction, whether up, down, or sideways. The payload carrying system can be a boat, aircraft, spacecraft, automobile, hovercraft, and submersible vehicles.

Normally, the radius of the rotating member 120, number of masses and mass weight depend directly on the weight of the payload carrying system.

A number of variations and modifications of the disclosed systems and methods can be used. It would be possible to provide for some features without providing others.

As will be appreciated, the drive members 124 can be replaced by any object that can resist rotation and briefly or longer change, even slightly, the spatial location of axle of rotation 153. For example, any mass may be rotated to provide angular momentum.

In an alternative embodiment, a stabilizing gyroscope can be positioned at the rotational axis 155 of rotating member 120 to permit rotating member 120 to be rotated. This embodiment is particularly useful where the payload carrying system is in free space and does not have the ability to push off of another object. Alternatively, a second propulsion system can be positioned adjacent to a first propulsion system and counter-rotated relative to one another to provide the same effect.

The plurality of drive members 124 positioned around the periphery of rotating member 120 may be replaced by a single drive member 124.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A propulsion system, comprising:
a rotation member having a length extending between first and second ends and an axle of rotation between the first and second ends transverse to the length;
a first mass coupled with the rotation member at the first end and rotatable relative to the rotation member about a first mass axis; and
a first motor configured to, while the rotation member is rotating about the axle of rotation, translate the axle of rotation along a path perpendicular to both the length and the axle of rotation by applying a force to accelerate rotation of the first mass about the first mass axis.

2. The propulsion system as set forth in claim 1, wherein the rotation member is rotatably coupled with a carriage.

3. The propulsion system as set forth in claim 1, further comprising an engine configured to rotate the rotation member about its axle of rotation.

4. The propulsion system as set forth in claim 1, wherein the first mass axis is parallel with the axle of rotation of the rotation member.

5. The propulsion system as set forth in claim 1, wherein the first motor further comprises a stepper motor.

6. The propulsion system as set forth in claim 1, further comprising:
a second mass coupled with the second end of the rotation member and rotatable relative thereto about a second mass axis; and
a second motor configured to, while the rotation member is rotating about the axle of rotation, translate the axle of rotation along a path perpendicular to both the length and the axle of rotation by applying a force to accelerate rotation of the second mass about the second mass axis.

7. The propulsion system as set forth in claim 6, wherein the second mass axis is parallel with the axle of rotation of the rotation member.

8. The propulsion system as set forth in claim 6, wherein the second motor further comprises a stepper motor.

9. A method for arranging a propulsion system, comprising:
providing a rotation member having a length extending between first and second ends and an axle of rotation between the first and second ends transverse to the length;
rotatably coupling a first mass with the first end of the rotation member; and
operatively coupling a first motor with the first mass such that the motor translates the axle of rotation along a path perpendicular to both the length and the axle of rotation by applying a force to accelerate rotation of the first mass about the first mass axis.

10. The method as set forth in claim 9, wherein providing the rotation member further comprises rotatably coupling the rotation member to a carriage.

11. The method as set forth in claim 10, further comprising operatively coupling an engine with the carriage and the rotation member such that the engine is configured to cause rotation of the rotation member about the axle of rotation.

12. The method as set forth in claim 9, wherein rotatably coupling the first mass with the first end further comprises rotatably coupling the first mass about a first mass axis parallel with the axle of rotation of the rotation member.

13. The method as set forth in claim 9, further comprising rotatably coupling a second mass with the second end of the rotation member.

14. The method as set forth in claim 13, wherein rotatably coupling the second mass with the second end further comprises rotatably coupling the second mass about a second mass axis parallel with the axle of rotation of the rotation member.

15. The method as set forth in claim 13, further comprising operatively coupling a second motor with the second mass such that the motor translates the axle of rotation along a path perpendicular to both the length and the axle of rotation by applying a force to accelerate rotation of the second mass about the second mass axis.

16. A method for propulsion, comprising:
to a payload carrying system, providing a rotation member having a length extending between first and second ends and an axle of rotation transverse to the length;
rotatably coupling a first mass with the first end of the rotation member;
rotating the rotation member relative to the carriage about the axle of rotation;
rotating the first mass relative to the rotation member;
with the rotation member and the first mass rotating, translating the payload carrying system along a travel path perpendicular to the axle of rotation by accelerating rotation of the first mass with a first motor.

17. The method as set forth in claim 16, wherein rotatably coupling the first mass with the first end further comprises rotatably coupling the first mass about a first mass axis parallel with the axle of rotation of the rotation member.

18. The method as set forth in claim 16, wherein accelerating rotation of the first mass further comprises, accelerating rotation of the first mass with a stepper motor.

19. The method as set forth in claim 16, further comprising:
rotatably coupling a second mass with the second end of the rotation member;
rotating the second mass relative to the rotation member; and
with the rotation member and the second mass rotating, translating the payload carrying system along a travel path perpendicular to the axle of rotation by accelerating rotation of the first mass with a first motor.

20. The method as set forth in claim 16, wherein rotatably coupling the second mass with the second end further comprises rotatably coupling the second mass about a second mass axis parallel with the axle of rotation of the rotation member.

21. The method as set forth in claim 16, wherein accelerating rotation of the second mass further comprises, accelerating rotation of the second mass with a stepper motor.
